(19) United States
(12) Patent Application Publication
(10) Pub. No.: US 2007/0079512 A1
(43) Pub. Date: Apr. 12, 2007

(54) Ratchet pruner with dual pivot lubrication bolts

(76) Inventors: Linn E. Nelson, Portland, OR (US); Karl H. Zeller, Portland, OR (US); Soon Kim Wong, Portland, OR (US)

Correspondence Address: PATENTTM.US, P. O. BOX 82788, PORTLAND, OR, 97282-0788, US

(21) Appl. No.: 11/245,987

(22) Filed: Oct. 7, 2005

(51) Int. Cl. B26B 13/28; B25F 3/00

(52) U.S. Cl. 30/123.3; 30/251

(57) ABSTRACT

A pruner employs dual lubricating fasteners as pivots. Each pivot has a head, and a shank which is provided with a lubricant cell and plural channels. The lubricant cell is in communication with the exterior of the shank area, the channels enabling the lubricant contained in the lubricant cell to lubricant the two blades. The lubricant cell includes a depressed oiling region for containing oil therein during re-lubrication. The shank has outer threads to mesh with inner threads of the nut. An anvil portion is provided in a material less likely to dull the blade portion. Extensible handles are providing, having lock member with square or rectangular lock iron for improved operation. A ratchet spring configuration provides ease of replacement of the spring.

### BACKGROUND OF THE INVENTION

This invention relates to pruning shears, and more particularly to a ratchet pruning shear employing dual pivot lubrication bolts.

Pruning shears employing ratchet mechanisms enable easier cutting of branches than would be possible with non-ratchet type pruners. The user is able to cut partially through a branch, the ratchet mechanism locks onto the branch while the user is able to re-open the handles of the pruner to close down further on the branch. Thus multiple actuations of the handles of the pruner may be employed to cut a single branch while requiring less exertion by the user at any individual actuation.

Having extensible handles on a pruner can be desirable, enabling adjustment of the overall length of the pruner and its reach, depending on the particular use or user. The conventional mechanism for allowing the extension employs a circular hole in a stationary portion of the handle tube, and that portion of the handle tube fits in a slidably extensible handle portion. A cylindrical lock member slides into the circular hole, to lock the handles at a given length. However, such configuration can lead to imprecise reciprocating motion of the pruner. The cylindrical lock member may be easily deformed. The cylinder/round hole results in a single point (tangent) application of force which can result in deformation of the holes in the handle, since typically users will slide the handles when adjusting the length, allowing the cylindrical lock to find the hole and snap into place with the extension (or retraction) handle length force being applied at the same time.

The ratcheting mechanisms of such pruners typically employ a spring member to assist in ratchet operation. Over time it may be necessary to replace the spring, but the typical configuration of the spring makes changing it difficult.

Typical pruners employ a metal cutting blade and a counterpart metal “anvil” which the blade will press against when performing cutting. There may be a tendency for the anvil to cause the blade to become dull more quickly, since the metal of the blade and anvil will meet when the pruner is fully closed.

### SUMMARY OF THE INVENTION

In accordance with the invention, a pruner having a ratchet system includes dual lubricating pivot bolts for connection of the pivoting portions of the pruner. The pivot bolt is provided with a lubricant cell with plural channels to distribute the lubricant to the mating areas of the pivoting members in the area of the pivot point, to effectively lubricate the pivoting members, thereby resulting in reduction in friction between the members. A lubricant receiving well is provided at the lubricant receiving position, for ease of re-supply of lubricant.

Accordingly, it is an object of the present invention to provide an improved pruner employing dual pivoting member joining device.

It is a further object of the present invention to provide an improved pruner using dual pivot point nut members with improved lubricant delivery and re-supply features thus promoting less tool wear and overall longevity.

It is yet another object of the present invention to provide an improved ratchet pruner employing dual oiler bolts for joining the pivoting portions of the pruner.

It is a further object of the present invention to provide an improved pruner with extensible handles having an improved locking mechanism for the extensible handles.

The subject matter of the present invention is particularly pointed out and distinctly claimed in the concluding portion of this specification. However, both the organization and method of operation, together with further advantages and objects thereof, may best be understood by reference to the following description taken in connection with accompanying drawings wherein like reference characters refer to like elements.

### BRIEF DESCRIPTION OF THE DRAWINGS

FIG. 1 is a view of a ratchet pruner using dual pivot lubricating bolts, in accordance with the invention;

FIG. 2 is an enlarged view of the head portion of the ratchet pruner;

FIG. 3 is an enlarged view of the handle extension features of the ratchet pruner;

FIG. 4 is a side transparent view of the lock mechanism of FIG. 3;

FIG. 5 is a view of a prior art ratchet mechanism spring;

FIG. 6 is an exploded view of a pivot lubricating bolt in accordance with the present invention;

FIG. 7 is a sectional view taken along line 3-3 of FIG. 6;

FIG. 8 is an exploded view of another embodiment of a pivoting lubricating bolt in accordance with the invention;

FIG. 9 is a sectional view of the embodiment of a pivoting lubricating bolt as shown in FIG. 8, taken along line 5-5;

FIG. 10 is a top sectional view illustrating placement of the lubrication channels;

FIG. 11 is a top sectional view showing alternative lubrication channel placement;

FIG. 12 is an alternative lubricating bolt;

FIG. 13 is a further alternative lubricating bolt; and

FIG. 14 is a cross section of an exemplary shape of handle portion 110.

### DETAILED DESCRIPTION

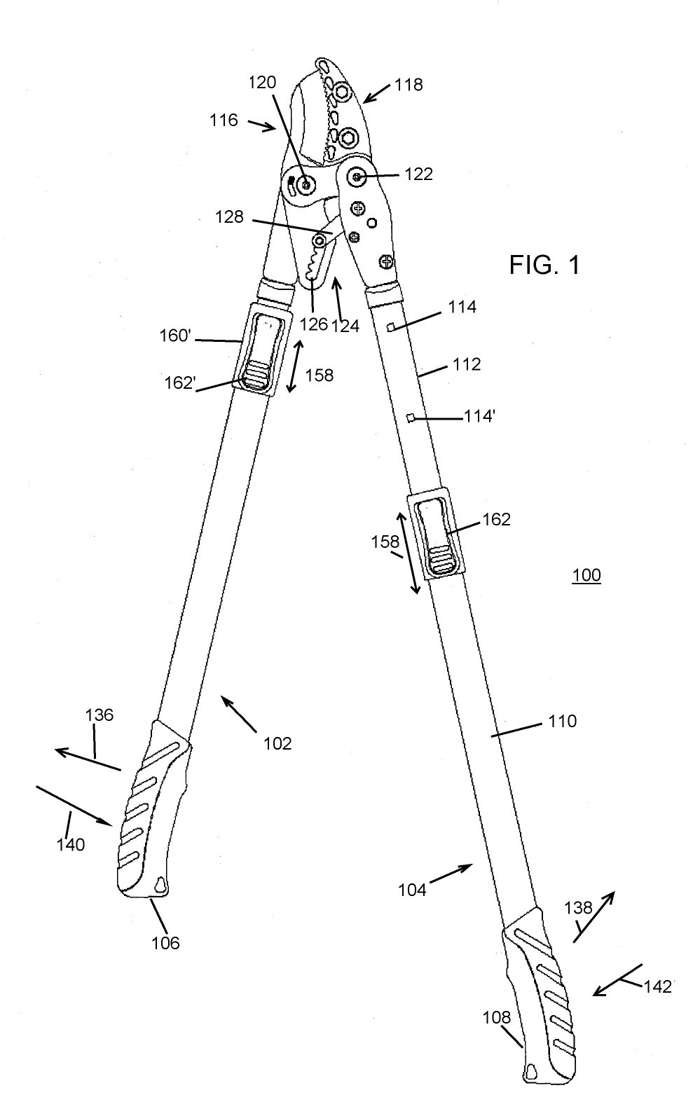

FIG. 1 is a view of a ratchet pruner in accordance with the present invention. The pruner 100 employs first and second extensible handles 102, 104 which carry ergonomic grips 106, 108 thereon. The grips are suitable TPR or other rubber or rubber like material that promotes comfort, reduced stress, supports ergonomic concepts and is resistant to UV light, oil, water and other environmental factors. Handle 104 comprises a first outer telescoping tubular portion 110 and a tubular portion 112 received in telescoping fashion within the interior of portion 110. Plural square depressions or openings 114, 114 are formed in the portion 112, suitably spaced at certain intervals along the extent of portion 112. Two such openings 114 are visible in FIG. 1, but it will be understood that corresponding additional openings 114 are formed along the extent of portion 112.

The handles 102, 104, connect to the pruner blade jaw portions 116 and 118, which employ pivot portions 120 and 122, suitable comprising oiler bolt members as discussed hereinbelow. A ratchet device 124 includes ratchet ramp 126 and rider 128.

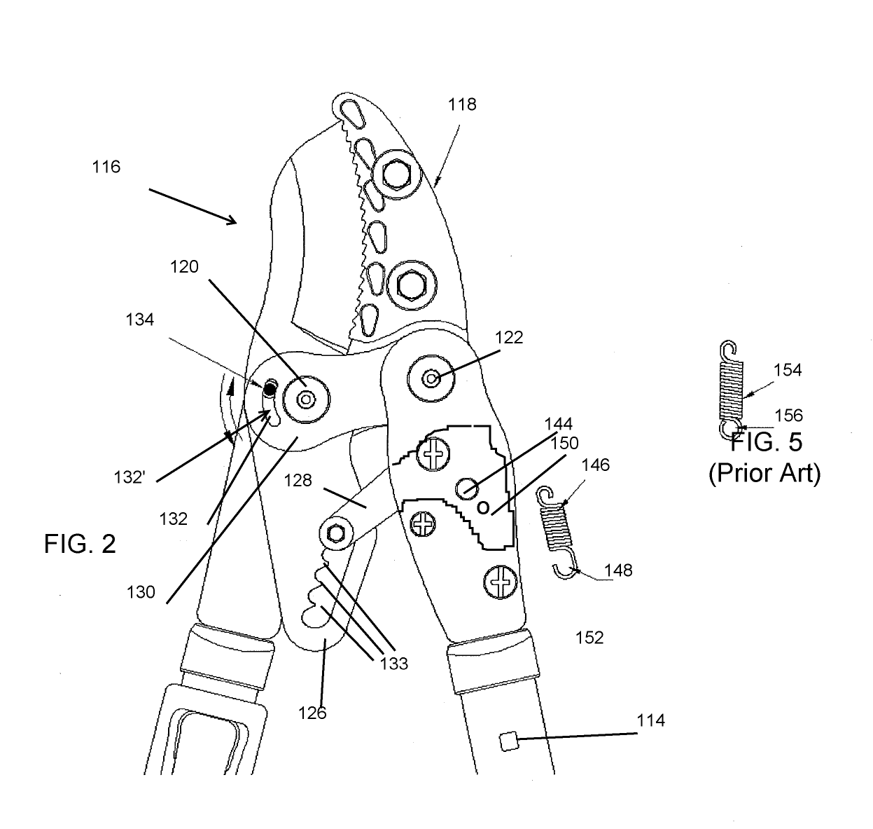

Referring to FIG. 2, an enlarged view of the head portion of the pruner, first and second pivot oiler bolt member 120, 122, interact with ramp 126 and rider 128, together with an interconnecting plate 130, which has curved slot 132 therein (ramp 126 having a corresponding slot 132 ), which receives pin 134 (mounted to jaw portion 116) to enable the cooperative movement of portion 116, 126 and 130 with the movement of handles 102 and 104 outwardly in the directions of arrows 136, 138 and then inwardly in the direction of arrows 140, 142 (see FIG. 1). This cooperation performs guiding and positioning of the components during operation, and results in the arrangement of the pruner components for providing precision operation of the ratchet function.

Portion 116 includes a sharpened curved blade 117, while portion 118 includes a corresponding mating “anvil” 119, having a corresponding counterpart curved surface portion to define a mating portion to the blade. Plural serrated portions 121 are provided on the portion 118 in an arc extending somewhat above the blade and anvil mating regions when the blade and anvil are fully engaged with one another. These serrations help in gripping a branch or other item while using the pruner to cut.

Ratchet rider portion 128 is pivotally mounted to pivot about pin 144, and includes a mounting point 150 (illustrated in phantom as the relevant portion of rider 128 is behind the external portion of the pruner) to receive spring 146′, an opposite end 148 of the spring being mounted to a pin 152, to effectuate the riding action of the rider to result in the ratchet action in cooperation with ratchet teeth 132 of the ramp 126.

The configuration of the spring 146 (shown removed from the pruner for illustration and contracted) is such that the opposite facing end portions of the spring enable easy removal and replacement of the spring if necessary, by use of needle nose pliers, for example, whereby the user can grasp the lower end 148 of the spring, pull downwardly to move the loop off of pin 152, then enabling the top of the spring to be disengaged from rider portion 150. This is in contrast with a prior art type spring 154 (FIG. 5), wherein the end portion 156 of the spring is a closed loop portion, requiring disassembly of a pruner to remove/insert the pin corresponding to pin 152, for replacing the spring.

A further rider stop member pin 151 is provided to the pruner, defining an extent of pivotal movement of the rider (which would occur in the case when the spring 146′ is maximally contracted). In FIG. 2, the rider is at its upward most extension. When the jaws of the pruner are fully opened, the end of the rider carrying portion 150 will rest on pin 151.

Portion 118, or at least the anvil portion 119 thereof, is suitably constructed of an ABS material, while the blade portion 118 is suitable a metal as would be typically employed for pruner blades. The ABS portion provides an anvil surface that is less hard than the blade and is therefore less damaging to the edge of the blade, which can lead to reducing the frequency of sharpening that might otherwise be required in prior art metal blade/metal anvil configurations. While ABS is the preferred material with the blade of metal, other material combinations may be employed where the mating portion of the anvil is of lesser hardness than the blade or is otherwise of a material less likely to dull the blade edge.

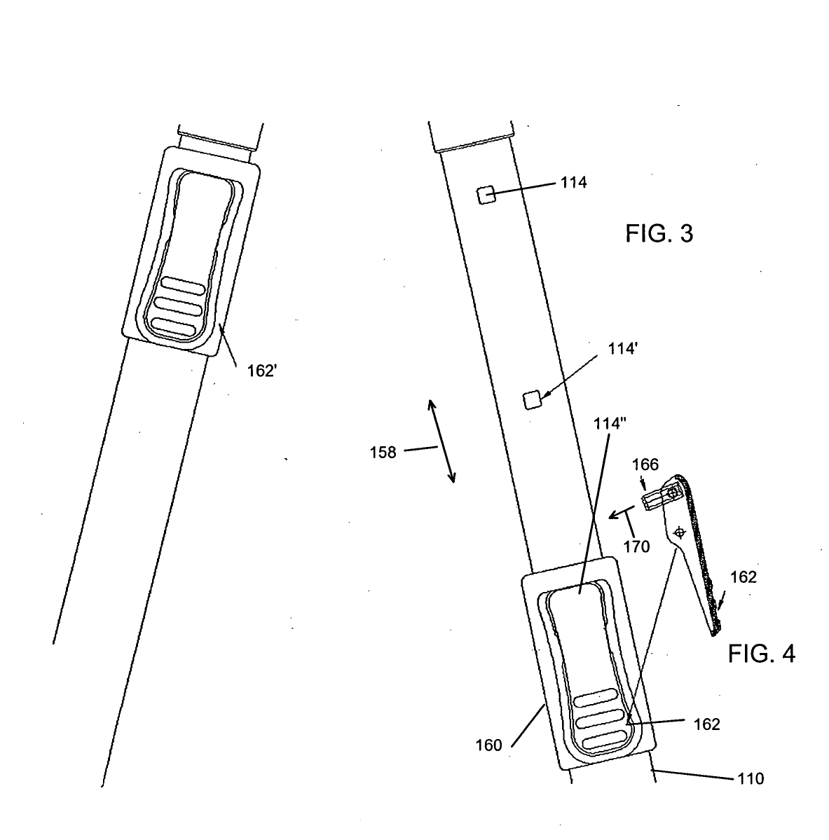

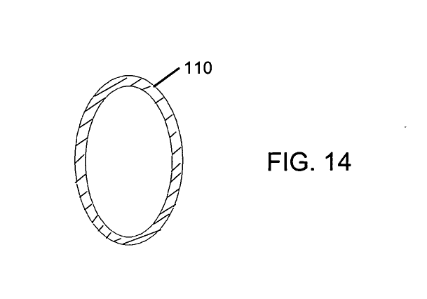

Referring now to FIG. 3, an enlarged view of the handle extension features of the ratchet pruner and FIG. 4, a side transparent view of the lock mechanism of FIG. 3, handle portion 110 receives handle portion 112 in the center thereof, in sliding engagement, to allow extension/retraction thereof along the directions indicated by arrows 158. Both handle portions are suitably oval shape in cross-section, and are of extruded aircraft aluminum to provide strong lightweight handles. FIG. 14, a cross sectional view of an exemplary handle portion 110, illustrates the oval or elliptical shape. Handle portion 110 carries a lock portion 160 which includes an actuation button 162, pivotally mounted to lock portion 160 via a pivot pin 164. A rectangular iron 166 (suitably square in the preferred embodiment) is pivotally mounted via pin 168 to the end of the button 162 nearest to the head of the pruner. The button is spring biased so that the rectangular iron is urged in the direction of arrow 170 in absence of user actuation, causing the iron to insert into opening 114, 114′, 114″, etc., when aligned adjacent the opening.

Thus, in operation, the handles will normally lock into a given position by the engagement of iron 166 and the particular opening (114, 114′, 114″, etc.). To adjust the overall length of the pruner handles, the user will depress the button 162, which will pivot the button on pivot pin 164, removing the iron 166, from the particular opening 114 (114′, 114″, etc.). The user may then slide the handle portion 110, 112, to reposition them to provide the desired length, allowing the iron 166 to reinsert into the opening 114 (114′, 114″, etc.) to provide the desired length to the pruner handles.

The square configuration of the iron 166 provides and improved engagement over the prior art.

In the preferred embodiment, there are 4 openings 114 spaced 4 inches (10.15 cm) apart, providing an adjustable handle length of between 19 inches (48.25 cm), 23 inches (58.4 cm), 27 inches (68.6 cm) and 31 inches (78.75 cm), where the length is measured between point 111 and 113 in FIG. 1.

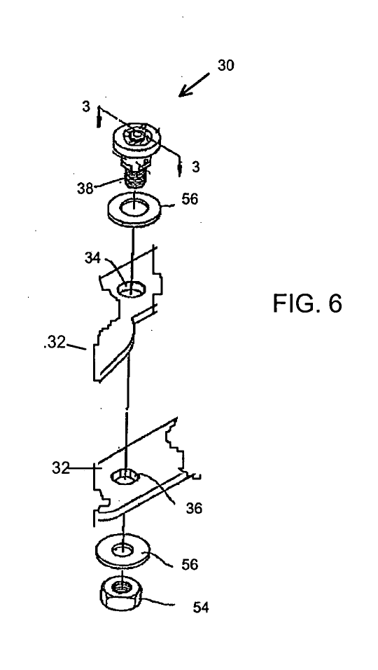

The lubricating bolts or oiler bolts 120, 122, are suitably constructed as noted in connection with FIGS. 6-12, for example.

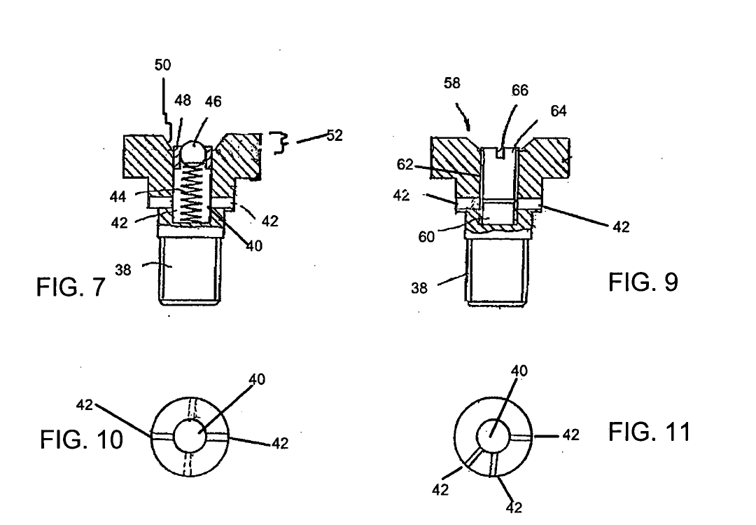

As shown in FIGS. 6 and 7, a pivot lubricating bolt 30, employed to join two portions 32 of a tool, such as the ratchet pruner. The portions of the tool 32 are provided with pivoting holes 34, 36 for receiving the pivot lubricating bolt 30. The pivoting hole 34 of the first blade is suitably round, whereas the pivoting hole 36 of the second blade is suitably rectangular.

The pivot lubrication bolt 30 is characterized by a head, and a shank. The shank is provided with a male threaded portion 38, a round segment contiguous to the head, a rectangular mid-segment located between the round segment and the male threaded portion, and a lubricant cell 40 with an open end extending through the head. The lubricant cell 40 is provided with two or more channels 42 in communication between the interior of the cell 40 and with the exterior of the shank. The lubricant cell 40 is provided with an elastic or biasing member 44, a covering member 46, and a stop member 48. The elastic member 44 is suitably a coil spring in the preferred embodiment. The covering member 46 is of a spherical construction and is located at the open end of the lubricant cell 40. Covering member may comprise a ball bearing, for example. The elastic member 44 and the covering member 46 are retained in the lubricant cell 40 by the stop member 48 which seals off the open end of the lubricant cell 40.

The covering member 46 and stop member 48 are suitably positioned centrally of the bolt, within a well portion 50 defined in the face of the bolt. The well is suitably formed as a bevel, so as to define a depth 52 between the top of the covering member and the outer face of the bolt 30.

The first and second portions 32 are held together in pivoting relation by the pivot lubrication bolt 30 in conjunction with a nut 54 and two washers 56 serving to reduce friction between the blades and the nut.

In use, as the covering member 46 is pressed against the coil spring 44, a gap is created between the covering member 46 and the stop member 48 in view of the covering member 46 being partially moved out of contact with the stop member 48. A lubricant, such as oil, for example, may then be injected into the lubricant cell 40 via the gap. The well portion 50 provides a holding area to receive the lubricant temporarily, until the lubricant may pass by the covering member into the lubricant cell 40. This enables an easier re-supply of the lubricant cell, without the likelihood that the lubricant will spill beyond the extent of the bolt, especially in the case where the lubricant supply nozzle is not precisely inserted into the opening of the stop member.

In use of the tool, the portions 32 are supplied the lubricant via the channels 42 of the lubricant cell 40. The plural channels are suitably arranged radially about the pivot axis so as to provide the lubricant where desired for maximum effect. The preferred embodiment employs 2 such channels, but more may be employed in different applications other than the illustrated shear. For example, in a configuration have 3 or 4 such channels, the channel diameter may be reduced to ensure a slower feed rate of the lubricant. The channels may be regularly spaced about the bolt, or, may be positioned irregularly, if the particular configuration of the pivoting members is such as to desire greater lubricant delivery in one region relative to another.

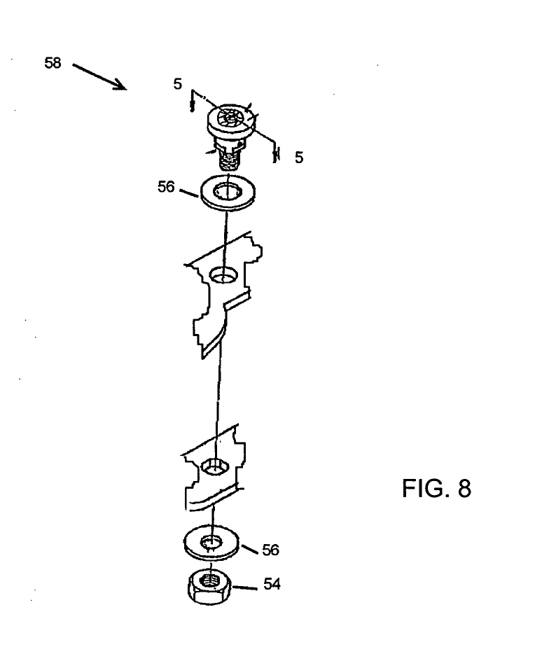

As shown in FIGS. 8 and 9, a second embodiment of the pivot lubrication bolt comprises a pivot 58 which has a corresponding configuration to that of the bolt 30 described hereinabove, but with a different construction of the lubricant cell. The lubricant cell 60 is receiving in the body of the bolt and is provided with an inner threaded potion 62 which is engaged with a plug member 64, the plug being provided at the outer end with a slotted head 66.

In this embodiment, before the lubricant is injected into the lubricant cell 60, a screw driver is used to turn the plug 64 such that the screw driver is engaged with the slotted head 66 of the plug 64. The plug is removed, and lubricant is added to the lubricant cell. The plug is then re-inserted into the opening. In use, to cause lubrication to be dispensed via the lubrication channels 42, a screwdriver or other suitable device is inserted into the slot 66, and the plug 64 is rotated to cause it to move inwardly toward the bottom of the lubricant cell. This causes the lubricant to be forced out of the lubricant cell via the channels. The amount of lubricant thereby dispensed can be controlled by the amount of rotation of the plug 64. This is particular useful in cases of using a lubricant which has a higher viscosity, and the lubricant suitably remains in the lubricant cell until the rotation of the plug member.

While the illustrated slotted head is of the “−” type for use with the “−” type screwdriver, and “+” type head or hexagonal head or square drive head may also be employed, for example, for actuation by “+” type drivers or square or hex head drivers.

The bolt 58 also employs the well portion 50 so as to provide a region to contain lubricant while refilling, to lessen the likelihood of spilling and to ensure that the lubricant will end up in the lubricant cell.

As noted above, two or more lubrication channels 42 may be employed in either of the illustrated embodiments. FIG. 10 is a top sectional view taken along line 6-6 of FIG. 7, showing a two channel configuration with the channels arranged on opposite sides of the bolt. Additional optional channels 42 are shown in phantom. FIG. 11 is a top sectional view showing a non-symmetrical channel arrangement.

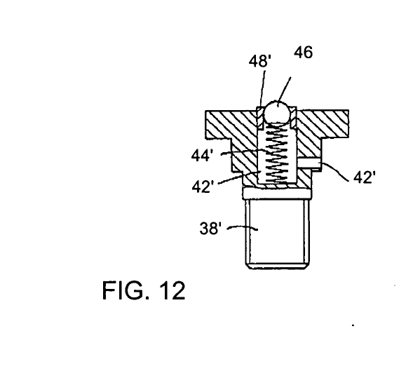

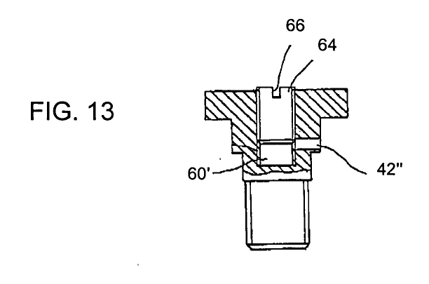

FIGS. 12 and 13 illustrate yet other configuration of the lubricating bolts, wherein the well portion is not present, and the top face of the bolt may be substantially co-planar with the top of covering member 46, or only slightly higher, or as in FIG. 12 and FIG. 13, lower.

Thus, an improved pruner is provided having multiple advantageous features, including improved blade/anvil cooperation for longer blade sharpness life, dual lubricating pivot bolt configuration, improved handle length adjustment locking mechanism, improved ratchet spring configuration for ease of replacement, improved precision ratchet operation.

While plural embodiments of the present invention has been shown and described, it will be apparent to those skilled in the art that many changes and modifications may be made without departing from the invention in its broader aspects. The appended claims are therefore intended to cover all such changes and modifications as fall within the true spirit and scope of the invention.

1. A pruner comprising:
first and second lubrication fasteners, wherein said lubrication fasteners are for joining at least two members for allowing pivoting of at least one member relative to the other, comprising:
a lubricant cell adapted to contain a lubricant positioned within each of said lubrication fasteners;
first and second extensible pruner arms adapted for adjusting an overall length thereof; and
first and second lock mechanism mounted relative to said first and second extensible arms for adjustably securing said arms at a particular length setting,
wherein at least one of said first and second extensible pruner arms comprises a first fixed arm portion and a second extensible arm portion that is extensible along a length of said first fixed arm portion, and wherein at least one of said first and second lock mechanisms comprises an insertable member mounted to said second extensible arm portion and plural corresponding mating receiving portions positioned in spaced relation to one another along a length of said first fixed arm portion for removably receiving said insertable member in ones of said receiving portions for locking said fixed and extensible arm portions relative to one another and,
wherein said insertable member comprises a rectangular cross section shape iron and said receiving portions comprise corresponding shaped openings for receiving said iron therein.

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. The pruner according to claim 21, wherein said iron is square cross section shape.

22. The pruner according to claim 21, wherein said lock mechanism further comprises a biasing element to urge said insertable member toward a position of insertion into said receiving portions.

23. The pruner according to claim 22, further comprising a retraction mechanism comprising a pivotally mounted actuation member having a first end cooperating with said insertion member and a second end for actuation by a user, whereupon on depression of the second end by the user, the first end pivots away from the respective receiving portion to remove the insertion member therefrom.

24. The pruner according to claim 22, further comprising a retraction mechanism comprising a pivotally mounted actuation member further cooperates with a biasing element to urge said insertable member toward a position of insertion into said receiving portions in absence of depressing of the actuation member by a user.

25. The pruner according to claim 1, further comprising a blade portion and a corresponding anvil portion that interacts with the blade by actuation of the handle members in cooperation with said pivoting of said lubrication members, wherein said blade portion comprises a metal and said anvil portion comprises a material of lesser hardness than said blade portion.

26. (canceled)

27. A pruner comprising:
a first fixed arm portion;
a second extensible pruner arms adapted for movement along a length of said first fixed arm portion; and
first and second lock mechanism mounted relative to said first and second arm portions for adjustably securing said arm portion in relative position to one another to provide a particular length adjustment setting,
wherein at least one of said first and second lock mechanisms comprises an insertable member mounted to said second extensible arm portion and plural corresponding mating receiving portions positioned in space relation to one another along a length of said first fixed arm portion for removably receiving said insertable member in ones of said receiving portions for locking said fixed and extensible arm portions relative to one another,
said insertable member comprises a rectangular cross section shape iron and said receiving portions comprise corresponding shaped openings for removably receiving said iron therein.

28. The pruner according to claim 27, wherein said iron is square cross section shape.

29. The pruner according to claim 27, wherein said lock mechanism further comprises a biasing element to urge said insertable member toward a position of insertion into said receiving portions.

30. The pruner according to claim 29, further comprising a retraction mechanism comprising a pivotally mounted actuation member having a first end cooperating with said insertion member and a second end for actuation by a user, whereupon on depression of the second end by the user, the first end pivots away from the respective receiving portion to remove the insertion member therefrom.

31. The pruner according to claim 29, further comprising a retraction mechanism comprising a pivotally mounted actuation member further cooperates with a biasing element to urge said insertable member toward a position of insertion into said receiving portions in absence of depressing at a sufficient force level of the actuation member by a user.

32. A pruner comprising:
a blade portion comprising a metal;
an anvil portion correspondent to said blade portion, said anvil portion comprising a material of lesser hardness than the blade or is otherwise of a material less likely to dull the blade edge;
a pivot mechanism to enable cooperative engagement of said blade portion and said anvil portion, said pivot mechanism including a lubricant cell adapted to contain a lubricant to provide lubrication during operation thereof.

33. (canceled)

34. The pruner according to claim 32, further comprising:
a first fixed arm portion;
a second extensible pruner arms adapted for movement along a length of said first fixed arm portion; and
first and second lock mechanism mounted relative to said first and second arm portions for adjustably securing said arm portion in relative position to one another to provide a particular length adjustment setting,
wherein at least one of said first and second lock mechanisms comprises an insertable member mounted to said second extensible arm portion and plural corresponding mating receiving portions positioned in space relation to one another along a length of said first fixed arm portion for removably receiving said insertable member in ones of said receiving portions for locking said fixed and extensible arm portions relative to one another,
said insertable member comprises a rectangular cross section shape iron and said receiving portions comprise corresponding shaped openings for removably receiving said iron therein.

35. The pruner according to claim 34, wherein said iron is square cross section shape.

36. The pruner according to claim 34, wherein said lock mechanism further comprises a biasing element to urge said insertable member toward a position of insertion into said receiving portions.

37. The pruner according to claim 36, further comprising a retraction mechanism comprising a pivotally mounted actuation member having a first end cooperating with said insertion member and a second end for actuation by a user, whereupon on depression of the second end by the user, the first end pivots away from the respective receiving portion to remove the insertion member therefrom.

38. The pruner according to claim 36, further comprising a retraction mechanism comprising a pivotally mounted actuation member further cooperating with the biasing element to urge said insertable member toward a position of insertion into said receiving portions in absence of depressing of the actuation member by a user.
